(19) United States
(12) Patent Application Publication
(10) Pub. No.: US 2014/0351616 A1
(43) Pub. Date: Nov. 27, 2014

(54) VOLTAGE-CONTROLLABLE POWER-MODE-AWARE CLOCK TREE, AND SYNTHESIS METHOD AND OPERATION METHOD THEREOF

(71) Applicants: Industrial Technology Research Institute, Hsinchu (TW); National Tsing Hua University, Hsinchu City (TW); Chung Yuan Christian University, Chung-Li (TW)

(72) Inventors: Yow-Tyng Nieh, Hsinchu County (TW); Shih-Chieh Chang, Hsinchu City (TW); Chung-Han Chou, New Taipei City (TW); Shih-Hsu Huang, Hsinchu County (TW)

(73) Assignees: Industrial Technology Research Institute, Hsinchu (TW); Chung Yuan Christian University, Chung-Li (TW); National Tsing Hua Univerisity, Hsinchu City (TW)

(21) Appl. No.: 14/019,546

(22) Filed: Sep. 6, 2013

(30) Foreign Application Priority Data
May 22, 2013 (TW) 102118074

(51) Int. Cl. G06F 1/32

(52) U.S. Cl. CPC G06F 1/324
USPC 713/322

(57) ABSTRACT

A voltage-controllable power-mode-aware (PMA) clock tree in an integrated circuit (IC) and a synthesis method and an operation method thereof are provided. The PMA clock tree includes at least two sub clock trees, at least two PMA buffers and a power mode control circuit. The at least two PMA buffers respectively delay a system clock and provide the delayed system clock to the sub clock trees as delayed clocks. The power mode control circuit respectively provides at least two first power information to at least two function modules to respectively determine the power modes of the function modules. The power mode control circuit respectively provides at least two second power information to the at least two PMA buffers to respectively determine the delay time of the PMA buffers.

### CROSS-REFERENCE TO RELATED APPLICATION

This application claims the priority benefit of Taiwan application serial no. 102118074, filed on May 22, 2013. The entirety of the above-mentioned patent application is hereby incorporated by reference herein and made a part of this specification.

### TECHNICAL FIELD

The technical field relates to a voltage-controllable power-mode-aware (PMA) clock tree, and a synthesis method and an operation method thereof.

### BACKGROUND

Integrated circuit (IC) designs with different power modes have been broadly adopted in order to reduce the power consumption. FIG. 1 is a diagram of a clock tree (or clock network) in a conventional IC 100. Referring to FIG. 1, the same IC (or chip) 100 is divided into different function modules, such as a micro-processor unit (MPU) function module 110 and a digital signal processor (DSP) function module 120. In a full-speed power mode, both the MPU function module 110 and the DSP function module 120 operate with their greatest power supply voltages through the operation of an internal (or external) control circuit of the IC 100. For example, both the power supply voltage V_{MPU} of the MPU function module 110 and the power supply voltage V_{DSP} of the DSP function module 120 are 1.0V. In a power mode with a specific operation condition, the power supply voltage V_{MPU} of the MPU function module 110 remains at 1.0V, while the power supply voltage V_{DSP} of the DSP function module 120 is reduced (for example, to 0.4V) to reduce the power consumption. In a power mode with another operation condition, the power supply voltage V_{DSP} of the DSP function module 120 remains at 1.0V, while the power supply voltage V_{MPU} of the MPU function module 110 is reduced to a lower voltage (for example, 0.4V). In an idle power mode, the power supply voltage V_{MPU} of the MPU function module 110 and the power supply voltage V_{DSP} of the DSP function module 120 are both reduced to 0.4V to reduce the power consumption.

At the stage of clock tree synthesis (CTS), an electronic design automation (EDA) software can automatically synthesize a clock tree. A clock tree usually engages multiple clock buffers (for example, the clock buffers 101-107 illustrated in FIG. 1) for sending a system clock CLK with a gain to the next clock buffer or another device. The system clock CLK can be sent to different devices (not shown, such as registers and/or other devices controlled by the system clock CLK) in the IC 100 via the clock tree. Ideally, the system clock CLK reaches different devices in the IC 100 at the same time via the clock tree. However, generally speaking, the system clock CLK reaches different devices in the IC 100 at different time points (i.e., the clock latencies) due to many factors, such as different transmission paths, different loads and so on. The time difference that the system clock CLK reaches different devices is referred to as clock skew.

An EDA software can increase/decrease the number of clock buffers regarding a specific operation condition, so as to adjust the delay time of the clock buffers 101-107 and optimize (minimize) the clock skew. For example, in the full-speed power mode (in which the power supply voltage of the MPU function module 110 and the power supply voltage of the DSP function module 120 are both 1.0V), the EDA software controls the clock latencies of the MPU function module 110 and the DSP function module 120 to be respectively 0.28 ns and 0.23 ns, so that the clock skew is 0.05 ns. However, because the power supply voltages have a big impact on the clock delays of the clock buffers, noticeable changes of time that the system clock reaches different function modules will be produced in different power modes. Clock skews between the MPU function module 110 and the DSP function module 120 in FIG. 1 in different power modes are listed in following table 1. When the power supply voltage V_{DSP} of the DSP function module 120 is reduced from 1.0V to 0.4V, the clock latency of the DSP function module 120 is increased to 7.00 ns, so that the clock skew between the MPU function module 110 and the DSP function module 120 is increased to 7.00−0.28=6.72 ns. When the power supply voltage V_{MPU} of the MPU function module 110 is reduced from 1.0V to 0.4V, the clock latency of the MPU function module 110 is increased to 9.37 ns, so that the clock skew between the MPU function module 110 and the DSP function module 120 is increased to 9.37−0.23=9.14 ns. When both the power supply voltage V_{MPU} of the MPU function module 110 and the power supply voltage V_{DSP} of the DSP function module 120 are reduced from 1.0V to 0.4V, the clock latency of the MPU function module 110 is increased to 9.37 ns, and the clock latency of the DSP function module 120 is increased to 7.00 ns, so that the clock skew between the MPU function module 110 and the DSP function module 120 is increased to 9.37−7.00=2.37 ns. Thus, the clock tree illustrated in FIG. 1 cannot satisfy the clock skew restriction in every power mode.

TABLE 1
clock skews between the MPU function module 110 and the DSP
function module 120 in FIG. 1 in different power modes

| | MPU function | | DSP function | | |
|---|---|---|---|---|---|
| | module 110 | | module 120 | | |
| Power | Power Supply | Clock | Power Supply | Clock | Clock |
| Mode | Voltage | Latency | Voltage | Latency | Skew |
| 1 | 1.0 V | 0.28 ns | 1.0 V | 0.23 ns | 0.05 ns |
| 2 | 1.0 V | 0.28 ns | 0.4 V | 7.00 ns | 6.72 ns |
| 3 | 0.4 V | 9.37 ns | 1.0 V | 0.23 ns | 9.14 ns |
| 4 | 0.4 V | 9.37 ns | 0.4 V | 7.00 ns | 2.37 ns |

Clock synchronization in multiple power modes can be accomplished through: (1) an asynchronous design; (2) the adoption of an adjustable delay buffer (ADB); and (3) the adoption of a delay locked loop (DLL). If an asynchronous design is adopted, a handshake protocol needs to be set up, which increases the complexity of system design and verification. Besides, an additional synchronization circuit is required for accomplishing data synchronization. If an ADB or a DLL is adopted, clock signals have to be sent back from different nodes of the clock tree to perform phase comparison. Accordingly, additional circuit design and disposition of the ADB or DLL have to be carried out, and the surface area of the IC is increased. Moreover, an additional reference clock is required by the ADB or DLL, and the selection of the reference clock will affect the performance of the clock synchronization design.

### SUMMARY

The present disclosure is directed to a voltage-controllable power-mode-aware (PMA) clock tree in an integrated circuit (IC) and a synthesis method and an operation method thereof, in which the clock skew between different function modules operating in different power modes is minimized.

The present disclosure provides a voltage-controllable PMA clock tree in an IC. The voltage-controllable PMA clock tree includes at least two sub clock trees, at least two PMA buffers, and a power mode control circuit. The at least two sub clock trees are respectively disposed in at least two function modules of the IC for respectively transmitting clock signals to different devices in the at least two function modules. The at least two PMA buffers are respectively coupled to the sub clock trees in the corresponding function modules. The at least two PMA buffers respectively delay a system clock to obtain the clock signals and respectively provide the clock signals to the sub clock trees in the function modules. The power mode control circuit is coupled to the at least two PMA buffers and the at least two function modules. The power mode control circuit respectively provides at least two first power information to the at least two function modules to respectively determine the power modes of the at least two function modules. The power mode control circuit respectively provides at least two second power information to the at least two PMA buffers to respectively determine the delay time of the at least two PMA buffers.

The present disclosure provides a synthesis method of a voltage-controllable power-mode-aware (PMA) clock tree in an integrated circuit (IC). The synthesis method includes following steps. At least two sub clock trees are respectively disposed in at least two function modules of the IC for transmitting clock signals to different devices in the function modules. At least two PMA buffers are disposed for delaying a system clock to obtain the clock signals, where each PMA buffer is coupled to the sub clock tree in the corresponding function module to provide the clock signal. A power mode control circuit is disposed, where the power mode control circuit respectively provides at least two first power information to the at least two function modules to respectively determine the power modes of the at least two function modules, and the power mode control circuit respectively provides at least two second power information to the at least two PMA buffers to respectively determine the delay time of the at least two PMA buffers.

The present disclosure provides an operation method of a voltage-controllable power-mode-aware (PMA) clock tree in an integrated circuit (IC). The voltage-controllable PMA clock tree includes at least two PMA buffers and at least two sub clock trees respectively disposed in at least two function modules of the IC. The operation method includes following steps. Clock signals are respectively transmitted by the at least two sub clock trees to different devices in the corresponding function modules. A system clock is respectively delayed by the at least two PMA buffers to obtain the clock signals, and the clock signals are respectively provided to the sub clock trees in the corresponding function modules. At least two first power information is respectively provided to the at least two function modules to respectively determine the power modes of the at least two function modules. At least two second power information is respectively provided to the at least two PMA buffers to respectively determine the delay time of the at least two PMA buffers.

As described above, in embodiments of the present disclosure, the delay time of different PMA buffers is respectively adjusted according to the second power information independent to the first power information, so that the clock skew between different function modules operating in different power modes can be reduced.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a diagram of a clock tree in a conventional integrated circuit (IC).

FIG. 2 is a circuit diagram of a power-mode-aware (PMA) clock tree in an IC according to an embodiment of the present disclosure.

FIG. 3 is a circuit diagram of a voltage-controllable PMA clock tree in an IC according to an embodiment of the present disclosure.

FIG. 4 is a circuit diagram of PMA buffers in FIG. 3 according to another embodiment of the present disclosure.

FIG. 5 is a circuit diagram of PMA buffers in FIG. 4 according to an embodiment of the present disclosure.

FIG. 6 is a flowchart of a synthesis method of a voltage-controllable PMA clock tree in an IC according to an embodiment of the present disclosure.

FIG. 7 is a flowchart of an operation method of a voltage-controllable PMA clock tree in an IC according to an embodiment of the present disclosure.

### DETAILED DESCRIPTION OF DISCLOSED EMBODIMENTS

The term “couple” used throughout the present disclosure (including the claims) can refer to any direct or indirect connection. For example, if a first device is described as being coupled to a second device, the first device can be directly connected to the second device or indirectly connected to the second device through any other device or any connection technique. In addition, wherever possible, like devices/elements/steps are referred to with like reference numerals throughout the present disclosure and accompanying drawings. Devices/elements/steps with the same reference numerals or terms in different embodiments can be referred to each other.

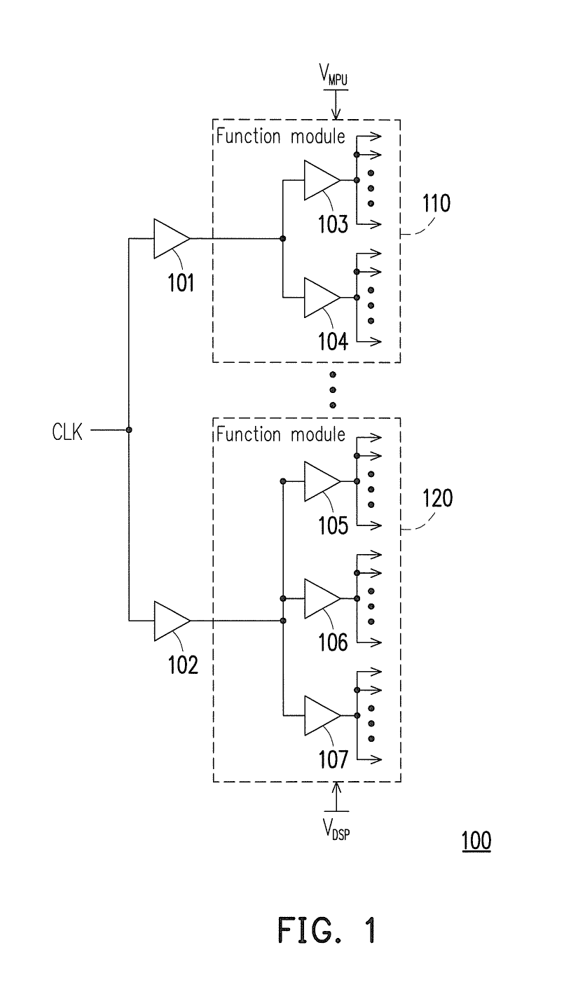

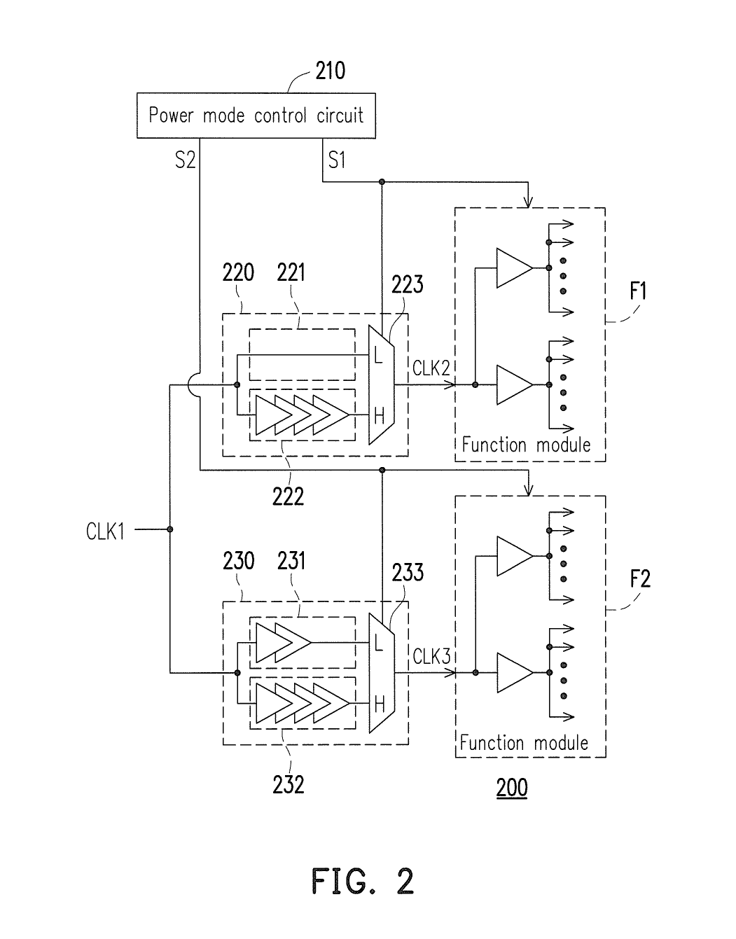

FIG. 2 is a circuit diagram of a power-mode-aware (PMA) clock tree in an integrated circuit (IC) 200 according to an embodiment of the present disclosure. The IC 200 has at least two function modules, such as the first function module F1 and the second function module F2 illustrated in FIG. 2. The first function module F1 and the second function module F2 may be microprocessors, microcontrollers, digital signal processors (DSP), memories and/or communication circuits, or any other functional circuits. For example, the first function module F1 is the micro-processor unit (MPU) function module 110 illustrated in FIG. 1, and the second function module F2 is the DSP function module 120 illustrated in FIG. 1. It should be noted that even though only two function modules are illustrated in FIG. 2, the present embodiment can be implemented with more function modules by referring to FIG. 2.

A power mode control circuit 210 inside (or outside) the IC 200 respectively provides at least two first power information to the at least two function modules to respectively determine the power modes of the at least two function modules. For example, the power mode control circuit 210 can change the power modes of the first function module F1 and the second function module F2 respectively through a power information S1 and a power information S2. The first function module F1 determines its power mode (for example, operating with a power supply voltage of 1.0V, 0.9V, 0.4V, or another value) according to the power information S1. The second function module F2 determines its power mode (for example, operating with a power supply voltage of 1.0V, 0.9V, 0.4V, 0V, or another value) according to the power information S2.

The PMA clock tree in FIG. 2 includes sub clock trees respectively disposed in the at least two function modules (for example, the function modules F1 and F2) and at least two PMA buffers (for example, the PMA buffers 220 and 230) outside the at least two function modules. At the stage of clock tree synthesis (CTS), an electronic design automation (EDA) software automatically deploy corresponding sub clock trees in the first function module F1 and the second function module F2. The EDA software can adjust the delay time of each buffer in a sub clock tree regarding a specific power mode (for example, the full-speed power mode), so as to optimize (minimize) the clock skew in the module-level sub clock tree.

At the stage of CTS, the PMA buffers 220 and 230 are disposed in the IC 200, and corresponding sub clock trees are respectively disposed in the function modules F1 and F2, as shown in FIG. 2. The PMA buffers 220 and 230 respectively determine the delay time of a system clock CLK1 according to the power information S1 and S2 and respectively delay the system clock CLK1 to obtain delayed clocks CLK2 and CLK3. After that, the PMA buffers 220 and 230 respectively provide the delayed clocks CLK2 and CLK3 to the sub clock trees in the function modules F1 and F2. The sub clock trees in the function modules F1 and F2 transmit the received delayed clocks CLK2 and CLK3 to different devices (not shown, such as registers and/or other devices controlled by the system clock CLK1) in the corresponding function modules.

To optimize the clock tree, in the present embodiment, the clock skew in multiple power modes is reduced by using the PMA buffers 220 and 230. The PMA buffers 220 and 230 generate clock delays corresponding to different power modes according to the power modes. For example, when the power mode determined according to the power information S1 and S2 indicates that both the function modules F1 and F2 operate with a specific voltage V1, the clock delay of the clock tree is optimized to determine the delay time corresponding to the voltage V1 in the PMA buffers 220 and 230.

After the clock delay of the PMA clock tree in the embodiment illustrated in FIG. 2 is optimized, the PMA buffer 220 includes a delay channel 221, a delay channel 222, and a switch unit 223, and the PMA buffer 230 includes a delay channel 231, a delay channel 232, and a switch unit 233. In the present embodiment, it is assumed that the power information S1 is a power supply voltage for providing the operation power of the first function module F1, and the power information S2 is a power supply voltage for providing the operation power of the second function module F2.

A first selection terminal and a second selection terminal of the switch unit 223 are respectively coupled to the delay channel 221 and the delay channel 222, and a common terminal of the switch unit 223 is coupled to the input terminal of the sub clock tree in the first function module F1. The switch unit 223 electrically connects the output terminal of the delay channel 221 or 222 to the input terminal of the sub clock tree in the first function module F1 according to the power information S1 of the first function module F1. For example, when the power information S1 indicates that the power supply voltage of the first function module F1 is a high-level voltage H (for example, 1.0V), the switch unit 223 electrically connects the output terminal of the delay channel 222 to the input terminal of the sub clock tree in the first function module F1. When the power information S1 indicates that the power supply voltage of the first function module F1 is a low-level voltage L (for example, 0.4V), the switch unit 223 electrically connects the output terminal of the delay channel 221 to the input terminal of the sub clock tree in the first function module F1.

A first selection terminal and a second selection terminal of the switch unit 233 are respectively coupled to the delay channel 231 and the delay channel 232, and a common terminal of the switch unit 233 is coupled to the input terminal of the sub clock tree in the second function module F2. The switch unit 233 electrically connects the output terminal of the delay channel 231 or 232 to the input terminal of the sub clock tree in the second function module F2 according to the power information S2 of the second function module F2. For example, when the power information S2 indicates that the power supply voltage of the second function module F2 is a high-level voltage H (for example, 1.0V), the switch unit 233 electrically connects the output terminal of the delay channel 232 to the input terminal of the sub clock tree in the second function module F2. When the power information S2 indicates that the power supply voltage of the second function module F2 is a low-level voltage L (for example, 0.4V), the switch unit 233 electrically connects the output terminal of the delay channel 231 to the input terminal of the sub clock tree in the second function module F2.

In the present embodiment, it is assumed that the clock delay of the clock buffers used by the delay channel 221, the delay channel 222, the delay channel 231, and the delay channel 232 is 0.04 ns with the power supply voltage of 1.0V, and the clock latencies of the function modules F1 and F2 are respectively 0.28 ns and 0.23 ns with the power supply voltage of 1.0V and are respectively 9.37 ns and 7.00 ns with the power supply voltage of 0.4V. After the clock delay of the PMA clock tree in the embodiment illustrated in FIG. 2 is optimized, 0 clock buffer is allocated for the delay channel 221, 227 clock buffers are allocated for the delay channel 222, 59 clock buffers are allocated for the delay channel 231, and 228 clock buffers are allocated for the delay channel 232. Clock skews between the function modules F1 and F2 in FIG. 2 in different power modes are listed in following table 2.

TABLE 2
clock skews between the function modules F1 and F2 in FIG. 2 in different power modes

| | Power Supply | Clock | | Power Supply | Clock | | |
|---|---|---|---|---|---|---|---|
| | Voltage of | Latency of | Clock Delay | Voltage of | Latency of | Clock Delay | |
| Power | Function | Function | of Delay | Function | Function | of Delay | Clock |
| Mode | Module F1 | Module F1 | Channel | Module F2 | Module F2 | Channel | Skew |
| 1 | 1.0 V | 0.28 ns | 9.08 ns | 1.0 V | 0.23 ns | 9.12 ns | 0.01 ns |
| 2 | 1.0 V | 0.28 ns | 9.08 ns | 0.4 V | 7.00 ns | 2.36 ns | 0.00 ns |
| 3 | 0.4 V | 9.37 ns | 0 ns | 1.0 V | 0.23 ns | 9.12 ns | 0.02 ns |
| 4 | 0.4 V | 9.37 ns | 0 ns | 0.4 V | 7.00 ns | 2.36 ns | 0.01 ns |

In a full-speed power mode 1 (i.e., the power supply voltages of the function modules F1 and F2 are both 1.0V), the PMA buffers 220 and 230 respectively select the delay channels 222 and 232 according to the power information S1 and S2. Thus, the clock latency of the function module F1 is (0.04*227)+0.28=9.08+0.28=9.36 ns, and the clock latency of the function module F2 is (0.04*228)+0.23=9.12+0.23=9.35 ns. Accordingly, an optimal clock skew (9.36−9.35=0.01 ns) is achieved.

When the power information S1 and S2 indicates that the function modules F1 and F2 currently operate in a power mode 2, the function module F1 operates with its greatest power supply voltage (for example, 1.0V), and the power supply voltage of the function module F2 is reduced (for example, to 0.4V). In the power mode 2, the PMA buffers 220 and 230 respectively select the delay channels 222 and 231 according to the power information S1 and S2. Thus, the clock latency of the function module F1 is (0.04*227)+0.28=9.08+0.28=9.36 ns, and the clock latency of the function module F2 is (0.04*59)+7.00=2.36+7.00=9.36 ns. Accordingly, an optimal clock skew (9.36−9.36=0.00 ns) is achieved.

When the power information S1 and S2 indicates that the function modules F1 and F2 currently operate in a power mode 3, the power supply voltage of the function module F1 is reduced (for example, to 0.4V), and the function module F2 operates with its greatest power supply voltage (for example, 1.0V). In the power mode 3, the PMA buffers 220 and 230 respectively select the delay channels 221 and 232 according to the power information S1 and S2. Thus, the clock latency of the function module F1 is (0.04*0)+9.37=0+9.37=9.37 ns, and the clock latency of the function module F2 is (0.04*228)+0.23=9.12+0.23=9.35 ns. Accordingly, an optimal clock skew (9.37−9.35=0.02 ns) is achieved.

When the power information S1 and S2 indicates that the function modules F1 and F2 currently operate in a power mode 4, the power supply voltages of the function module F1 and the function module F2 are both reduced (for example, to 0.4V). In the power mode 4, the PMA buffers 220 and 230 respectively select the delay channels 221 and 231 according to the power information S1 and S2. Thus, the clock latency of the function module F1 is (0.04*0)+9.37=0+9.37=9.37 ns, and the clock latency of the function module F2 is (0.04*59)+7.00=2.36+7.00=9.36 ns. Accordingly, an optimal clock skew (9.37−9.36=0.01 ns) is achieved.

Thereby, the PMA buffers 220 and 230 can dynamically compensate for the clock latency difference between the function module F1 and the function module F2 along with the power mode switching of the function module F1 and the function module F2, so as to allow the clock skew of the entire clock tree to satisfy the design specification. However, the PMA buffers 220 and 230 in FIG. 2 require 227+59+228=514 clock buffers. The large number of clock buffers not only consumes a lot of power but also takes up a large area in the IC.

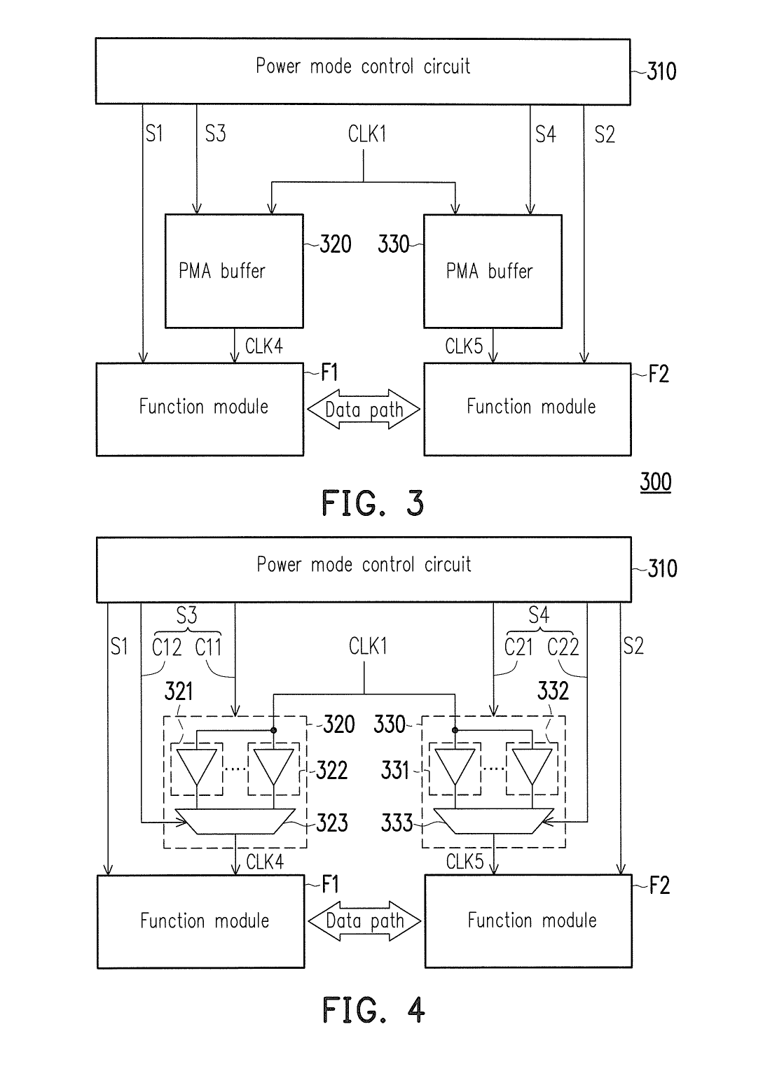

FIG. 3 is a circuit diagram of a voltage-controllable PMA clock tree in an IC 300 according to an embodiment of the present disclosure. The embodiment illustrated in FIG. 3 can be understood by referring to descriptions related to FIG. 2. Referring to FIG. 3, besides at least two function modules (for example, a first function module F1 and a second function module F2), the IC 300 further includes at least two PMA buffers (for example, the PMA buffers 320 and 330) and a power mode control circuit 310. The first function module F1 and the second function module F2 in FIG. 3 can be understood by referring to descriptions related to the first function module F1 and the second function module F2 in FIG. 2 therefore will not be described herein. It should be noted that even though only two function modules F1 and F2 are illustrated in FIG. 3, the present embodiment can be implemented with more function modules by referring to FIG. 3.

The PMA buffer 320 is coupled to the sub clock tree in the first function module F1, and the PMA buffer 330 is coupled to the sub clock tree in the second function module F2. The PMA buffer 320 delays the system clock CLK1 and provides the delayed system clock CLK1 to the clock input terminal of the sub clock tree in the first function module F1 as the delayed clock CLK4 of the first function module F1. The PMA buffer 330 delays the system clock CLK1 and provides the delayed system clock CLK1 to the clock input terminal of the sub clock tree in the second function module F2 as the delayed clock CLK5 of the second function module F2.

The power mode control circuit 310 is coupled to the PMA buffer 320, the PMA buffer 330, the first function module F1, and the second function module F2. The power mode control circuit 310 respectively provides at least two first power information (for example, a power information S1 and a power information S2) to the first function module F1 and the second function module F2 to respectively determine the power modes of the first function module F1 and the second function module F2. Besides, the power mode control circuit 310 respectively provides at least two second power information (for example, a power information S3 and a power information S4) to the PMA buffer 320 and the PMA buffer 330 to respectively determine the delay time of the PMA buffer 320 and the PMA buffer 330. The at least two first power information (S1 and S2) is independent to the at least two second power information (S3 and S4).

The power information S1 and the power information S2 can be implemented in any manner. For example, in some embodiments, the power information S1 and the power information S2 are power mode control signals. The first function module F1 determines the power supply voltage of the first function module F1 according to the first power mode control signal S1, and the second function module F2 determines the power supply voltage of the second function module F2 according to the second power mode control signal S2. Or, in some other embodiments, the power information S1 and the power information S2 are power supply voltages. The first power supply voltage S1 supplies operation power to the first function module F1, and the second power supply voltage S2 supplies operation power to the second function module F2.

The PMA buffer 320 and the PMA buffer 330 can be implemented in any manner. For example, in some embodiments, the PMA buffer 320 includes a single clock buffer (referred to as a first buffer circuit thereinafter), and the PMA buffer 330 includes a single clock buffer (referred to as a second buffer circuit thereinafter). The first buffer circuit is coupled to the sub clock tree in the first function module F1, and the second buffer circuit is coupled to the sub clock tree in the second function module F2. The at least two second power information (S3 and S4) includes a first control voltage and a second control voltage. The input terminal of the first buffer circuit of the PMA buffer 320 receives the system clock CLK1. The first buffer circuit of the PMA buffer 320 delays the system clock CLK1 for a first delay time under the control of the first control voltage S3 and serves the delayed system clock CLK1 as a first delayed clock CLK4. The output terminal of the first buffer circuit of the PMA buffer 320 is coupled to the clock input terminal of the sub clock tree in the first function module F1 to provide the first delayed clock CLK4. The input terminal of the second buffer circuit of the PMA buffer 330 receives the system clock CLK1. The second buffer circuit of the PMA buffer 330 delays the system clock CLK1 for a second delay time under the control of the second control voltage S4 and serves the delayed system clock CLK1 as a second delayed clock CLK5. The output terminal of the second buffer circuit of the PMA buffer 330 is coupled to the clock input terminal of the sub clock tree of the second function module F2 to provide the second delayed clock CLK5.

In the present embodiment, it is assumed that the clock delay of the first buffer circuit of the PMA buffer 320 and the clock delay of the second buffer circuit of the PMA buffer 330 are 0.04 ns with the power supply voltage of 1.0V and are 7.91 ns with the power supply voltage of 0.4V, and the clock latencies of the function modules F1 and F2 are respectively 0.28 ns and 0.23 ns with the power supply voltage of 1.0V and are respectively 9.37 ns and 7.00 ns with the power supply voltage of 0.4V. Clock skews between the function modules F1 and F2 in FIG. 3 in different power modes are listed in following table 3.

TABLE 3
clock skews between the function modules F1 and F2 in FIG. 3 in different power modes

| | clock Latency and | Clock Delay and | Clock Latency and | Clock Delay and | |
|---|---|---|---|---|---|
| | Power Supply | Power Supply | Power Supply | Power Supply | |
| Power | Voltage of Function | Voltage of PMA | Voltage of Function | Voltage of PMA | Clock |
| Mode | Module F1 | buffer 320 | Module F2 | buffer 330 | Skew |
| 1 | 0.28 ns (1.0 V) | 0.04 ns (1.0 V) | 0.23 ns (1.0 V) | 0.04 ns (1.0 V) | 0.05 ns |
| 2 | 0.28 ns (1.0 V) | 7.91 ns (0.4 V) | 7.00 ns (0.4 V) | 0.04 ns (1.0 V) | 1.15 ns |
| 3 | 9.37 ns (0.4 V) | 0.04 ns (1.0 V) | 0.23 ns (1.0 V) | 7.91 ns (0.4 V) | 1.27 ns |
| 4 | 9.37 ns (0.4 V) | 7.91 ns (0.4 V) | 7.00 ns (0.4 V) | 7.91 ns (0.4 V) | 2.37 ns |

When the first power information (S1 and S2) indicates that the first function module F1 and the second function module F2 current operate in a power mode 1, the power supply voltages of the first function module F1 and the second function module F2 are both high-level voltages (for example, 1.0V). In the power mode 1, the power mode control circuit 310 controls the PMA buffer 320 and the PMA buffer 330 through the at least two second power information (S3 and S4) to allow both the power supply voltage of the first buffer circuit of the PMA buffer 320 and the power supply voltage of the second buffer circuit of the PMA buffer 330 to be high-level voltages (for example, 1.0V). After the clock delay of the PMA clock tree in the embodiment illustrated in FIG. 3 is optimized, in the full-speed power mode (in which the power supply voltages of the function modules F1 and F2 are both 1.0V), the clock latency of the function module F1 is 0.04+0.28=0.32 ns, and the clock latency of the function module F2 is 0.04+0.23=0.27 ns. Accordingly, an optimal clock skew (0.32−0.27=0.05 ns) is achieved.

When the first power information (S1 and S2) indicates that the function module F1 and the function module F2 currently operate in a power mode 2, the power supply voltage of the first function module F1 is greater than the power supply voltage of the second function module F2 (for example, the power supply voltage of the first function module F1 is 1.0V and the power supply voltage of the second function module F2 is 0.4V). In the power mode 2, the power mode control circuit 310 respectively controls the PMA buffers 320 and 330 through the at least two second power information (S3 and S4) to allow the power supply voltage of the first buffer circuit of the PMA buffer 320 to be smaller than the power supply voltage of the second buffer circuit of the PMA buffer 330 (for example, to allow the power supply voltage of the second buffer circuit of the PMA buffer 330 to be a low-level voltage (for example, 0.4V) while the power supply voltage of the second buffer circuit of the PMA buffer 330 to be a high-level voltage (for example, 1.0V)). Thus, the clock latency of the function module F1 is 7.91+0.28=8.19 ns, and the clock latency of the function module F2 is 0.04+7.00=7.04 ns. Accordingly, the clock skew is 8.19−7.04=1.15 ns.

When the at least two first power information (S1 and S2) indicates that the first function module F1 and the second function module F2 currently operate in a power mode 3, the power supply voltage of the first function module F1 is smaller than the power supply voltage of the second function module F2 (for example, the power supply voltage of the first function module F1 is 0.4V and the power supply voltage of the second function module F2 is 1.0V). In the power mode 3, the power mode control circuit 310 respectively controls the PMA buffers 320 and 330 through the at least two second power information (S3 and S4), so as to allow the power supply voltage of the first buffer circuit of the PMA buffer 320 to be greater than the power supply voltage of the second buffer circuit of the PMA buffer 330 (for example, the power supply voltage of the first buffer circuit of the PMA buffer 320 is 1.0V, and the power supply voltage of the second buffer circuit of the PMA buffer 330 is 0.4V). Thus, the clock latency of the function module F1 is 0.04+9.37=9.41 ns, and the clock latency of the function module F2 is 7.91+0.23=8.14 ns. Accordingly, the clock skew is 9.41−8.14=1.27 ns. Thereby, the PMA buffers 320 and 330 can dynamically compensate for the clock latency difference between the function module F1 and the function module F2 in different power modes, so as to allow the clock skew of the entire clock tree to satisfy the design specification.

FIG. 4 is a circuit diagram of PMA buffers 320 and 330 in FIG. 3 according to another embodiment of the present disclosure. In the present embodiment, the power information S3 includes a selection signal C12 and a control voltage C11, and the power information S4 includes a selection signal C22 and a control voltage C21. The PMA buffer 320 includes a first buffer circuit composed of a plurality of delay channels (for example, the delay channels 321 and 322 in FIG. 4) and a switch unit 323, and the PMA buffer 330 includes a second buffer circuit composed of a plurality of delay channels (for example, the delay channels 331 and 332 in FIG. 4) and a switch unit 333. The switch units 323 and 333 can be switches, multiplexers, or any other selection circuits.

The input terminal (i.e., the delay channels 321 and 322) of the first buffer circuit receives the system clock CLK1. The switch unit 323 of the first buffer circuit selects a delay channel among the delay channels under the control of the selection signal C12. The switch unit 323 electrically connects the output terminal of one of the delay channels 321 and 322 to the sub clock tree in the first function module F1 according to the selection signal C12. The selected delay channel of the PMA buffer 320 delays the system clock CLK1 for a first delay time under the control of the control voltage C11 and provides the delayed system clock CLK1 to the clock input terminal of the sub clock tree in the first function module F1 through the switch unit 323 as a first delayed clock CLK4. The delay time of the delay channels 321 and 322 is controlled by the control voltage C11.

The input terminal (i.e., the delay channels 331 and 332) of the second buffer circuit receives the system clock CLK1. The switch unit 333 of the second buffer circuit selects a delay channel among the delay channels under the control of the selection signal C22. The switch unit 333 electrically connects the output terminal of one of the delay channels 331 and 332 to the sub clock tree in the second function module F2 according to the selection signal C22. The selected delay channel of the PMA buffer 330 delays the system clock CLK1 for a second delay time under the control of the control voltage C21 and provides the delayed system clock CLK1 to the clock input terminal of the sub clock tree in the second function module F2 through the switch unit 333 as a second delayed clock CLK5. The delay time of the delay channels 331 and 332 is controlled by the control voltage C21.

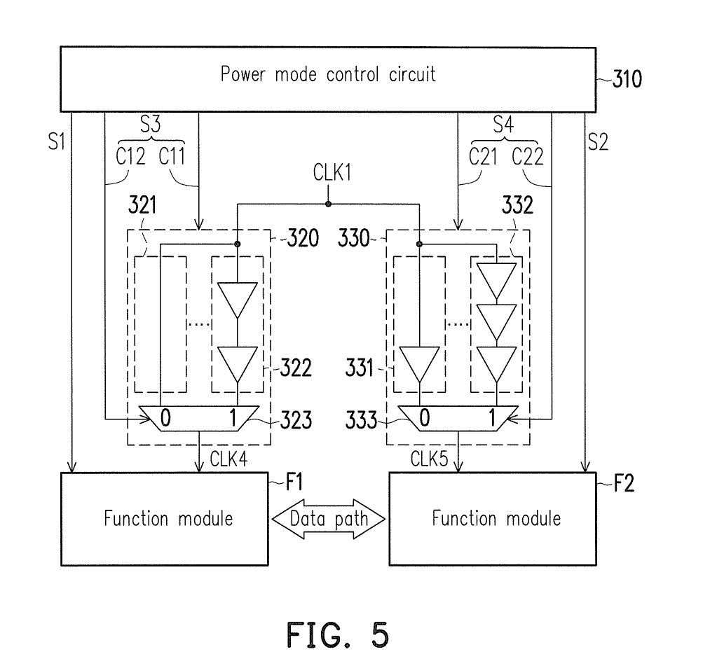

FIG. 5 is a circuit diagram of PMA buffers 320 and 330 in FIG. 4 according to an embodiment of the present disclosure. Referring to FIG. 5, in the present embodiment, 0 clock buffer is allocated for the delay channel 321, 2 clock buffers are allocated for the delay channel 322, 1 clock buffer is allocated for the delay channel 331, and 3 clock buffers are allocated for the delay channel 332. Herein it is assumed that the clock delays of the clock buffers used by the delay channels 321, 322, 331, and 332 are 0.04 ns with the power supply voltage of 1.0V and are 2.38 ns with the power supply voltage of 0.4V, and the clock delays of the switch units 323 and 333 are 0.12 ns with the power supply voltage of 1.0V and are 2.50 ns with the power supply voltage of 0.4V. It is further assumed that the clock latencies of the function modules F1 and F2 are respectively 0.28 ns and 0.23 ns with the power supply voltage of 1.0V and are respectively 9.37 ns and 7.00 ns with the power supply voltage of 0.4V. Clock skews between the function modules F1 and F2 in FIG. 5 in different power modes are listed in following table 4.

TABLE 4
clock skews between the function modules F1 and F2 in FIG. 5 in different power modes

| | Clock Latency | | | Clock Latency | | | |
|---|---|---|---|---|---|---|---|
| | and Power | Clock Delay and | | and Power | Clock Delay and | | |
| | Supply Voltage | Power Supply | | Supply Voltage | Power Supply | | |
| Power | of Function | Voltage of PMA | Signal | of Function | Voltage of PMA | Signal | Clock |
| Mode | Module F1 | buffer 320 | C12 | Module F2 | buffer 330 | C22 | Skew |
| 1 | 0.28 ns (1.0 V) | 0.00 ns (1.0 V) | 0 | 0.23 ns (1.0 V) | 0.04 ns (1.0 V) | 0 | 0.01 ns |
| 2 | 0.28 ns (1.0 V) | 4.76 ns (0.4 V) | 1 | 7.00 ns (0.4 V) | 0.04 ns (1.0 V) | 0 | 0.38 ns |
| 3 | 9.37 ns (0.4 V) | 0.00 ns (1.0 V) | 0 | 0.23 ns (1.0 V) | 7.14 ns (0.4 V) | 1 | 0.38 ns |
| 4 | 9.37 ns (0.4 V) | 0.00 ns (0.4 V) | 0 | 7.00 ns (0.4 V) | 2.38 ns (0.4 V) | 0 | 0.01 ns |

In a full-speed power mode 1 (i.e., the power supply voltages of the function modules F1 and F2 are both 1.0V), the power mode control circuit 310 controls the switch unit 323 to electrically connect the output terminal of the delay channel 321 to the sub clock tree in the first function module F1 through the selection signal C12 (logic 0), and the power mode control circuit 310 controls the switch unit 333 to electrically connect the output terminal of the delay channel 331 to the sub clock tree in the second function module F2 through the selection signal C22 (logic 0). Herein according to the control voltages C11 and C21, the power supply voltages of the delay channel 321, the switch unit 323, the delay channel 331, and the switch unit 333 are all 1.0V. Thus, the clock latency of the function module F1 is 0.00+0.12+0.28=0.40 ns, and the clock latency of the function module F2 is 0.04+0.12+0.23=0.39 ns. Accordingly, the clock skew is 0.40−0.39=0.01 ns.

When the power information S1 and S2 indicates that the function modules F1 and F2 currently operate in a power mode 2, the function module F1 operates with its greatest power supply voltage (for example, 1.0V), and the power supply voltage of the function module F2 is reduced (for example, to 0.4V). In the power mode 2, the power mode control circuit 310 controls the switch unit 323 to electrically connect the output terminal of the delay channel 322 to the sub clock tree in the first function module F1 through the selection signal C12 (logic 1), and the power mode control circuit 310 controls the switch unit 333 to electrically connect the output terminal of the delay channel 331 to the sub clock tree in the second function module F2 through the selection signal C22 (logic 0). Herein according to the control voltages C11 and C21, the power supply voltages of the delay channel 322 and the switch unit 323 are both 0.4V, and the power supply voltages of the delay channel 331 and the switch unit 333 are both 1.0V. Thus, the clock latency of the function module F1 is (2.38*2)+2.50+0.28=7.54 ns, and the clock latency of the function module F2 is 0.04+0.12+7.00=7.16 ns. Accordingly, the clock skew is 7.54−7.16=0.38 ns.

When the power information S1 and S2 indicates that the function modules F1 and F2 currently operate in a power mode 3, the power supply voltage of the function module F1 is reduced (for example, to 0.4V), and the function module F2 operates with its greatest power supply voltage (for example, 1.0V). In the power mode 3, the power mode control circuit 310 controls the switch unit 323 to electrically connect the output terminal of the delay channel 321 to the sub clock tree in the first function module F1 through the selection signal C12 (logic 0), and the power mode control circuit 310 controls the switch unit 333 to electrically connect the output terminal of the delay channel 332 to the sub clock tree in the second function module F2 through the selection signal C22 (logic 1). Herein according to the control voltages C11 and C21, the power supply voltages of the delay channel 321 and the switch unit 323 are both 1.0V, and the power supply voltages of the delay channel 332 and the switch unit 333 are both 0.4V. Thus, the clock latency of the function module F1 is 0.00+0.12+9.37=9.49 ns, and the clock latency of the function module F2 is (2.38*3)+2.50+0.23=9.87 ns. Accordingly, the clock skew is 9.87−9.49=0.38 ns.

When the power information S1 and S2 indicates that the function modules F1 and F2 currently operate in a power mode 4, the power supply voltages of the function module F1 and the function module F2 are both reduced (for example, to 0.4V). In the power mode 4, the power mode control circuit 310 controls the switch unit 323 to electrically connect the output terminal of the delay channel 321 to the sub clock tree in the first function module F1 through the selection signal C12 (logic 0), and the power mode control circuit 310 controls the switch unit 333 to electrically connect the output terminal of the delay channel 331 to the sub clock tree in the second function module F2 through the selection signal C22 (logic 0). Herein according to the control voltages C11 and C21, the power supply voltages of the delay channel 321, the switch unit 323, the delay channel 331, and the switch unit 333 are all 0.4V. Thus, the clock latency of the function module F1 is 0.00+2.50+9.37=11.87 ns, and the clock latency of the function module F2 is 2.38+2.50+7.00=11.88 ns. Accordingly, the clock skew is 11.88−11.87=0.01 ns.

Thereby, the PMA buffers 320 and 330 can dynamically compensate for the clock latency difference between the function module F1 and the function module F2 along with the power mode switching of the function module F1 and the function module F2, so as to allow the clock skew of the entire clock tree to satisfy the design specification. Compared to the PMA buffers 220 and 230 in FIG. 2 which require 227+59+228=514 clock buffers, the PMA buffers 320 and 330 in FIG. 5 require only 2+1+3=6 clock buffers. The greatly reduced number of clock buffers results in the reductions in power consumption and chip area.

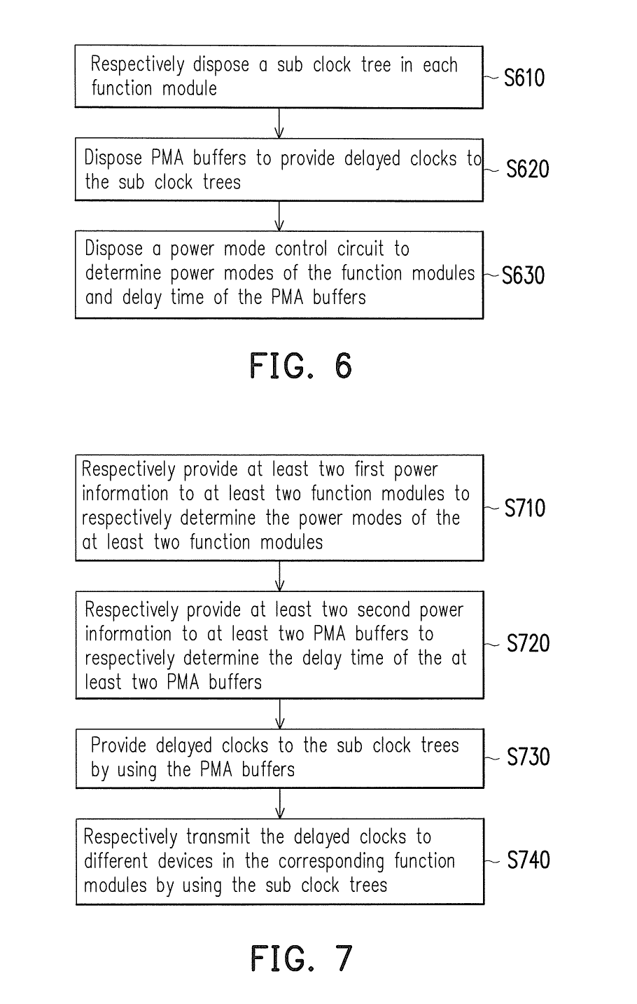

FIG. 6 is a flowchart of a synthesis method of a voltage-controllable PMA clock tree in an IC according to an embodiment of the present disclosure. The synthesis method includes following steps. A sub clock tree is disposed in each of at least two function modules of the IC (step S610), where the sub clock tree transmits a delayed clock to different devices (for example, registers and/or other devices controlled by the delayed clock) in the corresponding function module. At least two PMA buffers are disposed (step S620), where the PMA buffers respectively delay a system clock CLK1 to obtain the delayed clocks, each PMA buffer is coupled to the sub clock tree in the corresponding function module to provide the delayed clock. A power mode control circuit is disposed (step S630). The power mode control circuit respectively provides at least two first power information to the at least two function modules to respectively determine the power modes of the at least two function modules, and the power mode control circuit respectively provides at least two second power information to the at least two PMA buffers to respectively determine the delay time of the at least two PMA buffers, where the at least two first power information is independent to the at least two second power information.

FIG. 7 is a flowchart of an operation method of a voltage-controllable PMA clock tree in an IC according to an embodiment of the present disclosure. The PMA clock tree includes at least two PMA buffers and at least two sub clock trees respectively disposed in at least two function modules of the IC. The operation method includes following steps. At least two first power information is respectively provided to the at least two function modules to respectively determine the power modes of the at least two function modules (step S710). At least two second power information is respectively provided to the at least two PMA buffers to respectively determine the delay time of the at least two PMA buffers (step S720), where the at least two first power information is independent to the at least two second power information. A system clock CLK1 is respectively delayed by the at least two PMA buffers and respectively provided to the sub clock trees in the function modules as delayed clocks (step S730). The delayed clocks are respectively transmitted by the at least two sub clock trees to different devices in the corresponding function modules (step S740).

In some embodiments, the at least two first power information includes a first power mode control signal and a second power mode control signal, and the at least two function modules include a first function module and a second function module. The operation method further includes following steps. The power supply voltage of the first function module is determined according to the first power mode control signal, and the power supply voltage of the second function module is determined according to the second power mode control signal.

In some other embodiments, the at least two first power information includes a first power supply voltage and a second power supply voltage, and the at least two function modules include a first function module and a second function module. The operation method further includes following steps. The first power supply voltage is provided to the first function module to supply an operation power to the first function module, and the second power supply voltage is provided to the second function module to supply an operation power to the second function module.

In still some other embodiments, the at least two function modules include a first function module and a second function module, and the at least two PMA buffers include a first buffer circuit coupled to the sub clock tree in the first function module and a second buffer circuit coupled to the sub clock tree in the second function module. The operation method further includes following steps. When the at least two first power information indicates that the power supply voltage of the first function module is greater than the power supply voltage of the second function module, the at least two PMA buffers are controlled through the at least two second power information to allow the power supply voltage of the first buffer circuit to be smaller than the power supply voltage of the second buffer circuit. When the at least two first power information indicates that the power supply voltage of the first function module is smaller than the power supply voltage of the second function module, the at least two PMA buffers are controlled through the at least two second power information to allow the power supply voltage of the first buffer circuit to be greater than the power supply voltage of the second buffer circuit.

As described above, in multiple different power modes, the PMA clock tree in FIG. 2 supplies power to the PMA buffers 220 and 230 with a constant voltage and reduces the clock skew between the function modules F1 and F2 through the PMA buffers 220 and 230. In the case that the voltage difference between the function modules F1 and F2 is small (for example, the power supply voltages of the function modules F1 and F2 are respectively 0.9V and 1.2V and accordingly the voltage difference is only 0.3V), the PMA clock tree in FIG. 2 can effectively control the clock skew in different power modes. However, when the power supply voltage of a function module is reduced to an ultra-low voltage in a specific power mode, the voltage difference between the function modules becomes very large (for example, the power supply voltages of the function modules F1 and F2 are respectively 1.0V and 0.4V, and accordingly the voltage difference is 0.6V), the clock skew between the function modules becomes noticeable. It can be expected that when different function modules of an IC operate in different power modes (including the ultra-low voltage), the increased clock latencies and clock skew of the entire clock tree will become very challengeable.

Thereby, compared to the PMA clock tree in FIG. 2, the voltage-controllable PMA clock tree in FIG. 5 adopts a mechanism for controlling the power supply voltages of the PMA buffers (for example, the control voltages C11 and C21) and a mechanism for selecting delay channels of different clock delays in the PMA buffers (for example, the selection signals C12 and C22). The power supply voltages of the PMA buffers are adjusted through control voltages, and appropriate delay channels are selected through selection signals. Thus, the PMA clock tree in FIG. 5 can reduce the number of clock buffers disposed in the PMA buffers and satisfy the design requirements in clock skew, chip area, and power consumption. The PMA clock tree in FIG. 5 can adjust the clock outputs of the PMA buffers by using selection signals and control voltages, so as to reduce the clock skew between different function modules in different power modes.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A voltage-controllable power-mode-aware (PMA) clock tree in an integrated circuit (IC), comprising:
at least two sub clock trees, respectively disposed in at least two function modules of the IC, wherein each of the sub clock trees transmits a delayed clock to different devices in the corresponding function module;
at least two PMA buffers, respectively coupled to the sub clock trees in the corresponding function modules, wherein the at least two PMA buffer respectively delay a system clock to obtain the delayed clocks and respectively provide the delayed clocks to the sub clock trees in the function modules; and
a power mode control circuit, coupled to the at least two PMA buffers and the at least two function modules, wherein the power mode control circuit respectively provides at least two first power information to the at least two function modules to respectively determine power modes of the at least two function modules, and the power mode control circuit respectively provides at least two second power information to the at least two PMA buffers to respectively determine delay time of the at least two PMA buffers.

2. The voltage-controllable PMA clock tree according to claim 1, wherein the at least two first power information comprises a first power mode control signal and a second power mode control signal, the at least two function modules comprise a first function module and a second function module, the first function module determines a power supply voltage of the first function module according to the first power mode control signal, and the second function module determines a power supply voltage of the second function module according to the second power mode control signal.

3. The voltage-controllable PMA clock tree according to claim 1, wherein the at least two first power information comprises a first power supply voltage and a second power supply voltage, the at least two function modules comprise a first function module and a second function module, the first power supply voltage provides an operation power to the first function module, and the second power supply voltage provides an operation power to the second function module.

4. The voltage-controllable PMA clock tree according to claim 1, wherein the at least two function modules comprise a first function module and a second function module; the at least two PMA buffers comprise a first buffer circuit coupled to the sub clock tree in the first function module and a second buffer circuit coupled to the sub clock tree in the second function module; when the at least two first power information indicates that a power supply voltage of the first function module is greater than a power supply voltage of the second function module, the power mode control circuit controls the at least two PMA buffers through the at least two second power information to allow a power supply voltage of the first buffer circuit to be smaller than a power supply voltage of the second buffer circuit; and when the at least two first power information indicates that the power supply voltage of the first function module is smaller than the power supply voltage of the second function module, the power mode control circuit controls the at least two PMA buffers through the at least two second power information to allow the power supply voltage of the first buffer circuit to be greater than the power supply voltage of the second buffer circuit.

5. The voltage-controllable PMA clock tree according to claim 1, wherein the at least two second power information comprises a first control voltage and a second control voltage, and the at least two PMA buffers comprise:
a first buffer circuit, wherein an input terminal of the first buffer circuit receives the system clock, the first buffer circuit delays the system clock for a first delay time under the control of the first control voltage and serves the delayed system clock as a first delayed clock, and an output terminal of the first buffer circuit is coupled to the sub clock tree in a first function module among the at least two function modules to provide the first delayed clock; and
a second buffer circuit, wherein an input terminal of the second buffer circuit receives the system clock, the second buffer circuit delays the system clock for a second delay time under the control of the second control voltage and serves the delayed system clock as a second delayed clock, and an output terminal of the second buffer circuit is coupled to the sub clock tree in a second function module among the at least two function modules to provide the second delayed clock.

6. The voltage-controllable PMA clock tree according to claim 1, wherein the at least two second power information comprises a first selection signal, a second selection signal, a first control voltage, and a second control voltage, and the at least two PMA buffers comprise:
a first buffer circuit, wherein an input terminal of the first buffer circuit receives the system clock, the first buffer circuit selects a first selected delay channel among a plurality of first delay channels under the control of the first selection signal, the first selected delay channel delays the system clock for a first delay time under the control of the first control voltage and serves the delayed system clock as a first delayed clock, and an output terminal of the first buffer circuit is coupled to the sub clock tree in a first function module among the at least two function modules to provide the first delayed clock; and
a second buffer circuit, wherein an input terminal of the second buffer circuit receives the system clock, the second buffer circuit selects a second selected delay channel among a plurality of second delay channels under the control of the second selection signal, the second selected delay channel delays the system clock for a second delay time under the control of the second control voltage and serves the delayed system clock as a second delayed clock, and an output terminal of the second buffer circuit is coupled to the sub clock tree in a second function module among the at least two function modules to provide the second delayed clock.

7. The voltage-controllable PMA clock tree according to claim 6, wherein the first buffer circuit comprises:
the first delay channels, wherein input terminals of the first delay channels receive the system clock, and delay time of the first delay channels is controlled by the first control voltage; and
a switch unit, coupled between the first delay channels and the sub clock tree in the first function module, wherein the switch unit electrically connects an output terminal of one of the first delay channels to the sub clock tree in the first function module according to the first selection signal.

8. The voltage-controllable PMA clock tree according to claim 7, wherein the switch unit is a multiplexer.

9. A synthesis method of a voltage-controllable power-mode-aware (PMA) clock tree in an integrated circuit (IC), comprising:
respectively disposing a sub clock tree in at least two function modules of the IC to transmit delayed clocks to different devices in the corresponding function modules;
disposing at least two PMA buffers to delay a system clock as the delayed clocks, wherein each of the at least two PMA buffers is coupled to the sub clock tree in the corresponding function module to provide the delayed clock; and
disposing a power mode control circuit, wherein the power mode control circuit respectively provides at least two first power information to the at least two function modules to respectively determine power modes of the at least two function modules, and the power mode control circuit respectively provides at least two second power information to the at least two PMA buffers to respectively determine delay time of the at least two PMA buffers, wherein the at least two first power information is independent to the at least two second power information.

10. The synthesis method according to claim 9, wherein the at least two first power information comprises a first power mode control signal and a second power mode control signal, the at least two function modules comprise a first function module and a second function module, the first function module determines a power supply voltage of the first function module according to the first power mode control signal, and the second function module determines a power supply voltage of the second function module according to the second power mode control signal.

11. The synthesis method according to claim 9, wherein the at least two first power information comprises a first power supply voltage and a second power supply voltage, the at least two function modules comprise a first function module and a second function module, the first power supply voltage provides an operation power to the first function module, and the second power supply voltage provides an operation power to the second function module.

12. The synthesis method according to claim 9, wherein the at least two function modules comprise a first function module and a second function module, the at least two PMA buffers comprise a first buffer circuit coupled to the sub clock tree in the first function module and a second buffer circuit coupled to the sub clock tree in the second function module, and the synthesis method further comprises:
controlling the at least two PMA buffers through the at least two second power information to allow a power supply voltage of the first buffer circuit to be smaller than a power supply voltage of the second buffer circuit when the at least two first power information indicates that a power supply voltage of the first function module is greater than a power supply voltage of the second function module; and
controlling the at least two PMA buffers through the at least two second power information to allow the power supply voltage of the first buffer circuit to be greater than the power supply voltage of the second buffer circuit when the at least two first power information indicates that the power supply voltage of the first function module is smaller than the power supply voltage of the second function module.

13. An operation method of a voltage-controllable power-mode-aware (PMA) clock tree in an integrated circuit (IC), wherein the PMA clock tree comprises at least two PMA buffers and at least two sub clock trees respectively disposed in at least two function modules of the IC, and the operation method comprises:
respectively transmitting delayed clocks to different devices in the corresponding function modules by using the at least two sub clock trees;
respectively delaying a system clock by using the at least two PMA buffers to obtain the delayed clocks, and respectively providing the delayed clocks to the sub clock trees in the corresponding function modules;
respectively providing at least two first power information to the at least two function modules to respectively determine power modes of the at least two function modules; and
respectively providing at least two second power information to the at least two PMA buffers to respectively determine delay time of the at least two PMA buffers, wherein the at least two first power information is independent to the at least two second power information.

14. The operation method according to claim 13, wherein the at least two first power information comprises a first power mode control signal and a second power mode control signal, the at least two function modules comprise a first function module and a second function module, and the operation method comprises:
determining a power supply voltage of the first function module according to the first power mode control signal; and
determining a power supply voltage of the second function module according to the second power mode control signal.

15. The operation method according to claim 13, wherein the at least two first power information comprises a first power supply voltage and a second power supply voltage, the at least two function modules comprise a first function module and a second function module, and the operation method comprises:
providing the first power supply voltage to the first function module to provide an operation power to the first function module; and
providing the second power supply voltage to the second function module to provide an operation power to the second function module.

16. The operation method according to claim 13, wherein the at least two function modules comprise a first function module and a second function module, the at least two PMA buffers comprise a first buffer circuit coupled to the sub clock tree in the first function module and a second buffer circuit coupled to the sub clock tree in the second function module, and the operation method further comprises:
controlling the at least two PMA buffers through the at least two second power information to allow a power supply voltage of the first buffer circuit to be smaller than a power supply voltage of the second buffer circuit when the at least two first power information indicates that a power supply voltage of the first function module is greater than a power supply voltage of the second function module; and
controlling the at least two PMA buffers through the at least two second power information to allow the power supply voltage of the first buffer circuit to be greater than the power supply voltage of the second buffer circuit when the at least two first power information indicates that the power supply voltage of the first function module is smaller than the power supply voltage of the second function module.
